(19) United States
(12) Patent Application Publication
(10) Pub. No.: US 2019/0232818 A1
(43) Pub. Date: Aug. 1, 2019

(54) VEHICULAR CHILD SAFETY SYSTEM

(71) Applicant: Shantaveer Gangu, Memphis, TN (US)

(72) Inventor: Shantaveer Gangu, Memphis, TN (US)

(21) Appl. No.: 15/883,592

(22) Filed: Jan. 30, 2018

(51) Int. Cl. B60N 2/00; B60H 1/00; G08B 21/22; G08B 25/10; B60H 1/26

(52) U.S. Cl. CPC B60N 2/002; B60H 1/00742; B60N 2/28; G08B 25/10; B60H 1/267; G08B 21/22

(57) ABSTRACT

A vehicular child safety system is provided. The vehicular child safety system is adapted to first detect if a child has been left in a vehicle unattended, and then adapted to help the child through utilizing currently provided technology present in today's vehicles. The vehicular child safety system may be retrofitted to pre-existing vehicles with sufficient electronic functionality. The present invention embodies a method for preventing harm to such a child by automatically improving ventilation and providing access through automatically opening windows and unlocking doors, as well as by automatically contacting emergency services if no intervention is provided to remove the child from the vehicle within a predetermined time, thereby ensuring that the child is in safe environment as soon as possible.

### BACKGROUND OF THE INVENTION

The present invention relates to vehicle safety systems and, more particularly, to a system for detecting if a child has been left in a vehicle unattended, wherein the system takes proactive steps to ensure the safety of such child.

The tragedies of children being left unattended in parked cars is unfortunately well documented. Such tragedies have resulted in many heat stroke related deaths of and injuries to children across the nation, and surely the world. Currently, there is no alert mechanism in vehicles, or that can be retrofit to pre-existing vehicles, if a parent or caregiver forgets to take the child with them prior to locking the vehicle and leaving. Even if there is a device, the present invention uses currently available technology in any standard vehicle to retrofit a child safety system incorporating the vehicles sensors and output devices, such as door and lock sensors, window control properties, alarm systems, communication attributes, and seat belt recognition technologies, and integrating these functionalities into a new way to save the children's lives.

As can be seen, there is a need for a system for detecting if a child has been left in a vehicle unattended, and aiding the effort to help said child through utilizing currently provided technology present in today's vehicles. The present invention embodies a method for preventing harm to such a child by automatically improving ventilation and providing access through automatically opening windows and unlocking doors, as well as by automatically contacting emergency services if no intervention is provided to remove the child from the vehicle within a predetermined time, thereby ensuring that the child is in safe environment as soon as possible.

### SUMMARY OF THE INVENTION

In one aspect of the present invention, a vehicular child safety system includes a weight detection device configured to confirm a child occupant in a plurality of seats of a vehicle; a control circuitry configured to operative associate with a plurality of electronic functionality of the vehicle; the control circuitry providing a first set of preconditions that define when the child occupant is unattended in the vehicle, wherein if the first set of preconditions are met a first engagement is enabled; and the first engagement including selectively controlling power window functionality of the plurality of electronic functionality.

In another aspect of the present invention, the vehicular child safety system further includes the definition of an unattended child occupant being confirming only one or more child occupants and an ignition detection element of said plurality of electronic functionality detects that the ignition is off, wherein the first engagement further includes selectively controlling output functionality of the plurality of electronic functionality, wherein said output functionality includes a horn and/or lights of the vehicle, wherein said definition further includes a power lock system of said plurality of electronic functionality determines that a plurality of doors of the vehicle are in a locked condition, wherein the first engagement further includes moving the plurality of doors to an unlocked condition, the control circuitry further providing a second set of preconditions that define when the child occupant is unattended for a predetermined time, wherein if the second set of preconditions are met a second engagement is enabled; and the second engagement including selectively controlling telecommunication and global position systems of the plurality of electronic functionality to transmit a telephonic message with the global position of the vehicle to another party, the second engagement including selectively controlling telecommunication and global position systems of the plurality of electronic functionality to transmit an electronic message with the global position of the vehicle to another party, wherein the first engagement further includes selectively controlling output functionality of the plurality of electronic functionality, wherein said output functionality includes a horn and/or lights of the vehicle, and wherein the weight detection device is a seatbelt reminder sensor of said plurality of electronic functionality.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a perspective view of an exemplary embodiment of the present invention, demonstrating an inactive condition;

FIG. 3 is a perspective view of an exemplary embodiment of the present invention, demonstrating an active condition; and

FIG. 4 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicular child safety system adapted to first detect if a child has been left in a vehicle unattended, and then adapted to help the child through utilizing currently provided technology present in today's vehicles. The vehicular child safety system may be retrofitted to pre-existing vehicles with sufficient electronic functionality. The present invention embodies a method for preventing harm to such a child by automatically improving ventilation and providing access through automatically opening windows and unlocking doors, as well as by automatically contacting emergency services if no intervention is provided to remove the child from the vehicle within a predetermined time, thereby ensuring that the child is in safe environment as soon as possible.

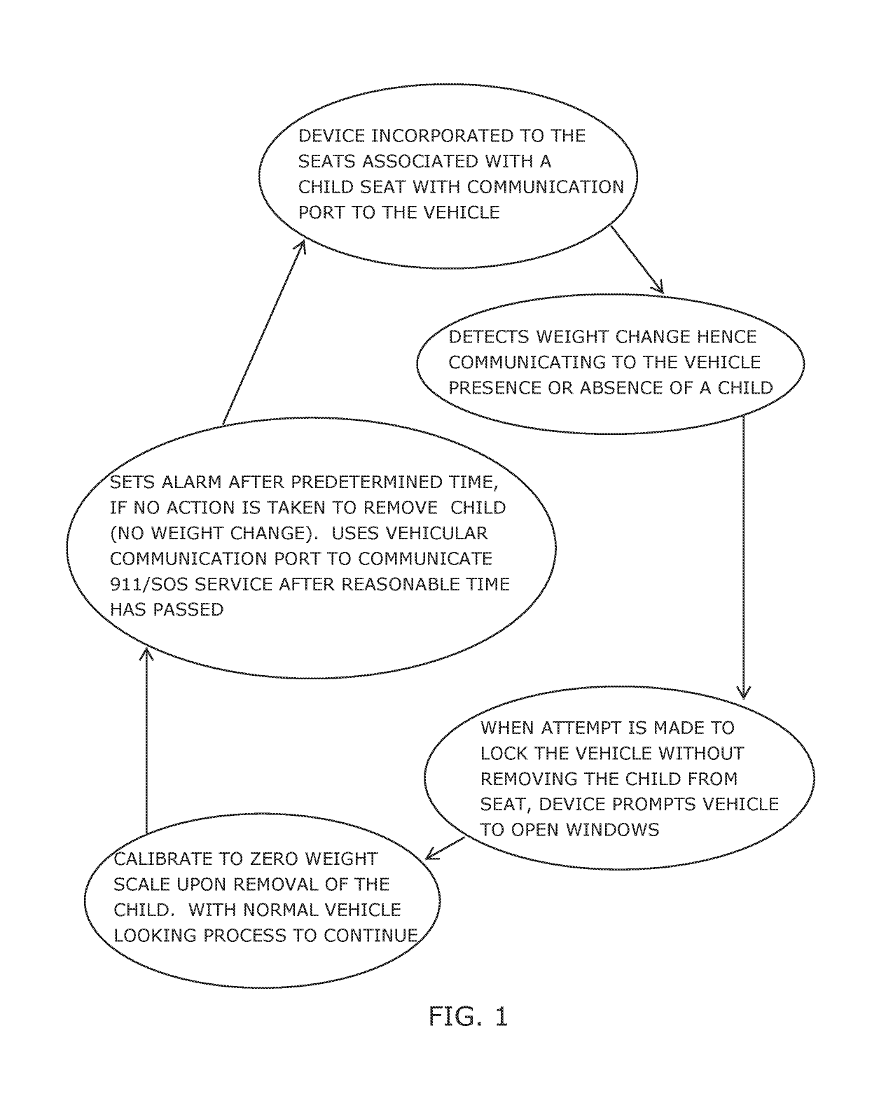

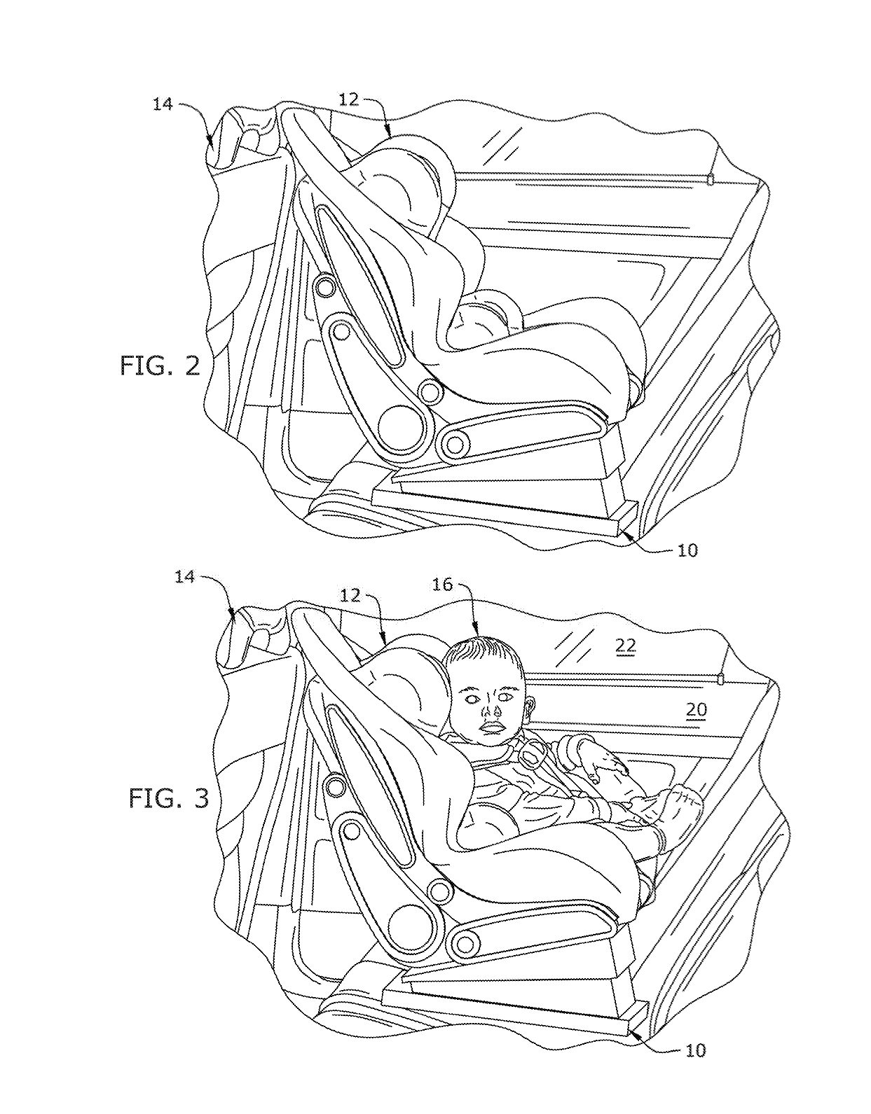

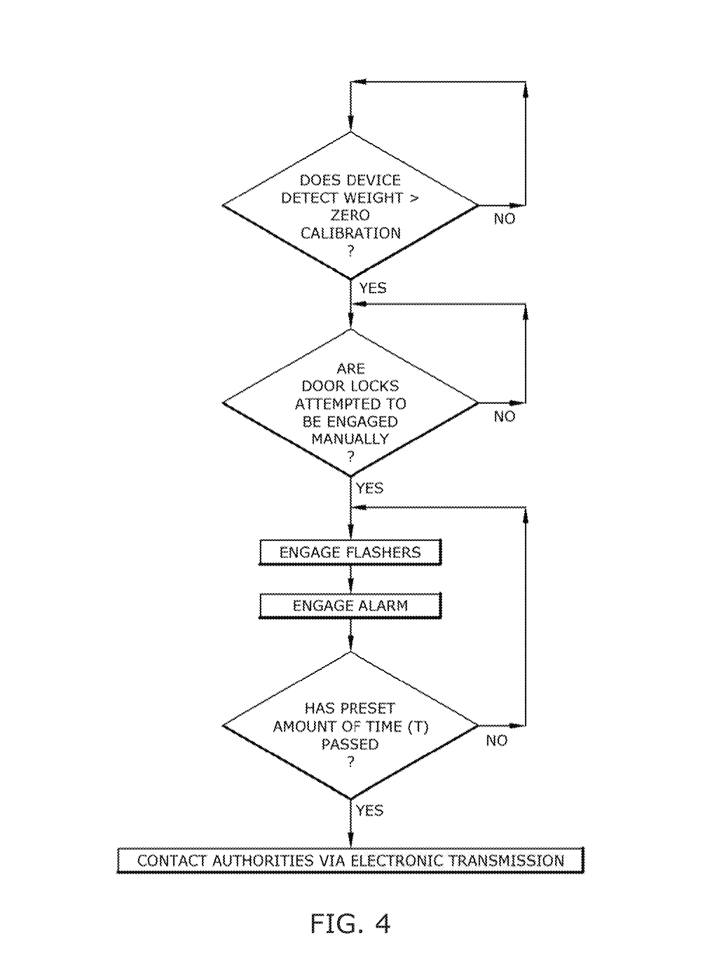

Referring to FIGS. 1 through 4, the present invention may include a vehicular child safety system for detecting if a child has been left in a vehicle unattended, and then aiding in the effort to protect the child through utilizing currently provided technology present in today's vehicles, wherein the vehicular child safety system can be retrofit to pre-existing vehicles. The vehicular child safety system of the present invention embodies the following three components:

1. A weight sensing device 10 for detecting the presence of a child 16 in a car seat 12 designed for children. The instant system may be enabled through a control circuitry/microprocessor to operatively associate the weight sensing device 10 with the electronic functionality of the vehicle 14. Such an association may be through am electrical (e.g., wireless, such as Bluetooth) connection to the vehicle 14 command center, or provided through a surrogate device that can be coupled to the vehicle's onboard diagnostic computer. The weight sensing device 10 may, of course, be a preexisting sensor currently utilized by the vehicle's seat belt recognition technology for seatbelt reminders (SBR), wherein a SBR sensor mounted to the seat is adapted to detect a seat occupant in order to trigger an audio and/or visual warning if unbuckled. Thereby the weight sensing device 10 or SBR sensor is adapted to determine a child occupant. The control circuitry/microprocessor may be adapted to operatively engage electronic functionality of the vehicle 14 regarding the presence of the child 16 after certain preconditions have been met, such as first set and a second set of rules, through a set of first and second engagements, respectively. The circuitry/microprocessor may be coupled to said electronic functionality via an electrical connection (e.g., wireless, such as Bluetooth) so long as the vehicular child safety system functions in accordance with the present invention as described herein. Said electronic functionality may include the preexisting SBR sensors, ignition detection elements, power window and power door lock functionalities, the telecommunication and global positioning systems, and the like.

2. The first set of rules/preconditions may include that when the vehicle 14 is turned off (and in some embodiment only if the doors are locked) while the weight sensing device 10 confirms a child seat occupant (i.e., without the child 16 being removed from the car seat) then the first engagement is enabled. The first engagement may include selectively operating the power windows, the power door locks, and/or the alarm system. The power windows 22 of the vehicle 14 may be opened automatically to improve ventilation. The power door locks may be automatically unlocked to provide ease of access to the child 16. The alarm system may be enabled to providing audio and visual output (e.g., sirens/honking and flashing vehicle lights for attracting the attention of a passerby).

3. The second set of rules/preconditions may include that, when in vehicles with telecommunication facilities, if no attempt is made to attend to said child 16 after a predetermined time then a second engagement may be enabled. An attempt to attend to said child 16 may be determined by the instant system through operatively associating with pre-existing door sensors used to determine whether a car door 20 is (or has been) opened or ajar, and similar sensors to confirm whether a door 20 has been moved from a locked condition to an unlocked condition, within the predetermined time period. The enabled second engagement may include, through the instant system operatively associating with the pre-existing telecommunication and global positioning systems of the vehicle 14, an automated telephone call can be placed to the SOS/911 operator indicating the nature of situation and/or a call or text message sent to an owner of the vehicle 14 (with a prerecorded message and coordinates for the vehicle location). The predetermined time can be selectively set to be ten or fifteen minutes, for example.

A method of using the present invention may include the following. The vehicle safety system disclosed above may be provided. A user may add the weight detection device 10 to the child seat 12, most likely in the 2nd and 3rd row of seats of the vehicle 14, though it would also work for the front seat. Alternatively, the user may supply the control circuitry/microprocessor adapted to operatively associate with the preexisting electronic functionality of the vehicle 14.

Associating a determination of a sufficient change or no sufficient change in determined weight of the car seat 12 may be provided through a weight module of the control circuitry/microprocessor. Such weight module may be adapted to monitor and selectively control the locked condition of the doors and positioning of the power windows for determining if the first set of rules/preconditions have been met, and for enabling the first engagement. The weight module may also be adapted to provide a timing element to set and calculate the passage of predetermined times for determining if the second set of rules/preconditions has been met and enabling the second engagement.

It should be understood, of course, that the foregoing relates to exemplary embodiments of the invention and that modifications may be made without departing from the spirit and scope of the invention as set forth in the following claims.

What is claimed is:

1. A vehicular child safety system, comprising:
a weight detection device configured to confirm a child occupant in a plurality of seats of a vehicle;
a control circuitry configured to operative associate with a plurality of electronic functionality of the vehicle;
the control circuitry providing a first set of preconditions that define when the child occupant is unattended in the vehicle, wherein if the first set of preconditions are met a first engagement is enabled; and
the first engagement including selectively controlling power window functionality of the plurality of electronic functionality.

2. The vehicular child safety system of claim 1, wherein the definition of said unattended child occupant includes confirming only one or more child occupants and an ignition detection element of said plurality of electronic functionality detects that the ignition is off.

3. The vehicular child safety system of claim 2, wherein the first engagement further includes selectively controlling output functionality of the plurality of electronic functionality.

4. The vehicular child safety system of claim 3, wherein said output functionality includes a horn and/or lights of the vehicle.

5. The vehicular child safety system of claim 2, wherein said definition further includes a power lock system of said plurality of electronic functionality determines that a plurality of doors of the vehicle are in a locked condition.

6. The vehicular child safety system of claim 5, wherein the first engagement further includes moving the plurality of doors to an unlocked condition.

7. The vehicular child safety system of claim 6, the control circuitry providing a second set of preconditions that define when the child occupant is unattended for a predetermined time, wherein if the second set of preconditions are met a second engagement is enabled; and
the second engagement including selectively controlling telecommunication and global position systems of the plurality of electronic functionality to transmit a telephonic message with the global position of the vehicle to another party.

8. The vehicular child safety system of claim 7, the second engagement including selectively controlling telecommunication and global position systems of the plurality of electronic functionality to transmit an electronic message with the global position of the vehicle to another party.

9. The vehicular child safety system of claim 8, wherein the first engagement further includes selectively controlling output functionality of the plurality of electronic functionality.

10. The vehicular child safety system of claim 9, wherein said output functionality includes a horn and/or lights of the vehicle.

11. The vehicular child safety system of claim 1, wherein the weight detection device is a seatbelt reminder sensor of said plurality of electronic functionality.

12. The vehicular child safety system of claim 11, wherein the vehicular child safety system is retrofitted to the vehicle.

13. The vehicular child safety system of claim 10, wherein the weight detection device is a seatbelt reminder sensor of said plurality of electronic functionality.

14. The vehicular child safety system of claim 13, wherein the vehicular child safety system is retrofitted to the vehicle.

15. A method of retrofitting a vehicular child safety system to a preexisting vehicle, comprising the steps of:
providing the vehicular child safety system of claim 13; and
operatively associating the control circuitry to the electronic functionality of said vehicle.
